(19) United States
(12) Patent Application Publication
(10) Pub. No.: US 2008/0231057 A1
(43) Pub. Date: Sep. 25, 2008

(54) SYSTEM AND METHOD FOR HARVESTING ELECTRICAL POWER FROM MARINE CURRENT USING TURBINES

(76) Inventor: Kenneth W. Zeuner, Orchid, FL (US)

Correspondence Address: RATNERPRESTIA, P O BOX 980, VALLEY FORGE, PA, 19482-0980, US

(21) Appl. No.: 12/052,259

(22) Filed: Mar. 20, 2008

Related U.S. Application Data
(60) Provisional application No. 60/918,924, filed on Mar. 20, 2007.

(51) Int. Cl. F03B 17/00; F03B 3/14; F16K 99/00

(52) U.S. Cl. 290/54; 416/117; 416/106; 137/861

(57) ABSTRACT

A water turbine powered electrical generation system is disclosed. The generation system includes a water-driven turbine completely submerged below a flowing water source. The flowing water source rotates the turbine, which is coupled to an electrical generator. The electrical generator generates electrical power for distribution away from the electrical generation system. The electrical generation system may be located on a floating or submersible platform.

### CROSS REFERENCE TO RELATED APPLICATIONS

The present application claims priority from U.S. Provisional Patent Application Ser. No. 60/918,924, filed on Mar. 20, 2007.

### BACKGROUND OF THE INVENTION

Water turbines have been used for hundreds of years to harness the power of flowing water. Water wheels and water driven propellers may be coupled to output devices such as electrically generators, to use the energy generated by the water flowing past them.

It would be beneficial to provide a water turbine and power generating system that harnesses the power of natural continuous energy in the form of flowing water and converts that power to a useable power without requiring the consumption of fossil fuel.

### SUMMARY OF THE INVENTION

Briefly, the present invention provides a water turbine comprising a rotatable body having a central hub portion and a plurality of spoke panels. Each of the plurality of spoke panels has a spoke panel coupled end coupled to the body at the central hub portion and a spoke panel free end extending radially away from the central axis. The turbine also includes a plurality of gates. Each of the plurality of gates has a gate coupled end pivotally coupled to the spoke panel free end of each of the plurality of spoke panels and a gate free end for pivoting movement between an open position and a closed position wherein the gate free end is in releasable engagement with an adjacent spoke panel. Each gate is independent of the remaining gates.

The present invention also includes a water turbine module assembly comprising a housing comprising an inlet, an outlet, and a turbine compartment disposed between the inlet and the outlet. A turbine is disposed within the turbine compartment, wherein the turbine includes an axis of rotation. A directional means is disposed at the inlet for directing a fluid from the inlet toward one side of the axis of rotation.

Also, the present invention provides a water turbine generator station comprising a frame having an upstream portion and a downstream portion and a water turbine module releasably disposed within the downstream portion. An electrical generator module is releasably disposed within the downstream portion, adjacent to the water turbine module. An inlet flow module is releasably disposed in the upstream portion adjacent to the water turbine module.

Further, the present invention provides an inlet flow module for a water turbine comprising a frame having an upstream portion and a first guard comprising a plurality of restraint members. The first guard is obliquely disposed across the upstream portion of the frame. Each of the plurality of restraint members is spaced from an adjacent restraint member by a predetermined distance. A second guard is disposed downstream of the first guard. The second guard comprises a mesh screen extending across the frame. A louvered door is disposed downstream of the second guard, wherein the louvered door is remotely operable.

Additionally, the present invention provides a power generation module comprising a watertight compartment configured to enclose an electrical generator. The watertight compartment includes at least one actuator extending therethrough. A non-watertight compartment is in electrical communication with the watertight compartment.

Further, the present invention provides an electrical generating barge comprising a hull having a plurality of compartments and a water turbine disposed within a first of the plurality of compartments. An electrical generator is coupled to the water turbine. The electrical generator is disposed within a second of the plurality of compartments. The hull may be ballasted to locate the water turbine below a water level.

### BRIEF DESCRIPTION OF THE DRAWINGS

The foregoing summary, as well as the following detailed description of an exemplary embodiment of the invention, will be better understood when read in conjunction with the appended drawings, which are incorporated herein and constitute part of this specification. For the purposes of illustrating the invention, there are shown in the drawings exemplary embodiments of the invention. It should be understood, however, that the invention is not limited to the precise arrangements and instrumentalities shown. In the drawings, which are not drawn to scale, the same reference numerals are employed for designating the same elements throughout the several figures. In the drawings:

FIG. 1 is a perspective view of a first exemplary embodiment of a water turbine according to the present invention;

FIG. 2 is a top plan view of the water turbine of FIG. 1, with a top cover removed;

FIG. 3 is an enlarged perspective view of a portion of the water turbine of FIGS. 1 and 2, showing an open gate;

FIG. 4 is a top plan view of a second exemplary embodiment of a water turbine according to the present invention, with a top cover removed;

FIG. 5 is an enlarged perspective view of a portion of the water turbine of FIGS. 3 and 4, showing an open gate;

FIG. 6 is a side elevational view of a first exemplary embodiment of a turbine module according to the present invention, incorporating the turbine of FIGS. 4 and 5, rotated to provide its axis in a horizontal plane;

FIG. 7 is a perspective view of the turbine module of FIG. 6, with the top cover removed;

FIG. 8 is a side elevational view of a second exemplary embodiment of a turbine module according to the present invention, incorporating the turbine of FIGS. 1-3, rotated to provide its axis in a horizontal plane;

FIG. 9 is a bottom perspective view of the turbine module of FIG. 8;

FIG. 10 is a perspective view of a stationary electrical generation station according to an exemplary embodiment of the present invention;

FIG. 11 is a side view of the stationary electrical generation station of FIG. 10;

FIG. 12 is a perspective view of a power generation module according to an exemplary embodiment of the present invention;

FIG. 13 is a schematic view of the power generation module of FIG. 12;

FIG. 13A is a side elevational view of a power generation module being lowered into the stationary electrical generation station of FIGS. 10 and 11;

FIG. 14 is a perspective view, partially broken away, of a submersible barge according to an exemplary embodiment of the present invention;

FIG. 14A is a perspective view, partially broken away, of a submersible barge according to an alternative exemplary embodiment of the present invention;

FIG. 15 is a schematic drawing of a plurality of the barges shown in FIG. 14 coupled to a control station;

FIG. 16 is a side elevational view of an exemplary embodiment of a floating barge shown adjacent to a pier;

FIG. 17 is a sectional view of the floating barge of FIG. 16, taken along lines 17-17 of FIG. 16;

FIG. 18 is a top plan view of a first alternative embodiment of a series of turbine modules for use with the floating barge shown in FIG. 16;

FIG. 19 is a top plan view of a second alternative embodiment of a series of turbine modules for use with the floating barge shown in FIG. 16;

FIG. 20 is an enlarged top plan view of a turbine module shown in FIG. 19;

FIG. 21 is a perspective view of a turbine assembly according to an exemplary embodiment of the present invention; and

FIG. 22 is a perspective view of a turbine assembly according to an alternative exemplary embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Certain terminology is used herein for convenience only and is not to be taken as a limitation on the present invention. The terminology includes the words specifically mentioned, derivatives thereof, and words of similar import. It will be appreciated that the spirit and scope of the invention is not limited to the embodiments selected for illustration. Also, it should be noted that the drawings are not rendered to any particular scale or proportion. It is contemplated that any of the configurations and materials described hereafter can be modified within the scope of this invention.

Referring to the figures in general, a water turbine generated power system is disclosed. The power system may be used to harness the power of flowing water, such as in a river or in an ocean current. The turbine can operate as a single unit or in conjunction with additional units. The power system and modules that comprise the power system are completely compatible with the environment and marine life.

Output power of a turbine (in watts) can be calculated by using Newton's Third Law:

Power=½ρAV³Cp (Equation 1)

Where:
Power=Watts
ρ=density of water (1,025 kg/m³)
A=area of rotor blades (m²)
V=current velocity (m/s)
Cp=turbine efficiency

According to the present invention, a turbine may be installed in a stationary module that is located in a river bed or sea floor, or alternatively, in a floating platform, such as a barge that floats on the top of the water surface or a submersible unit that may be lowered a predetermined depth into an ocean. While specific embodiments of turbines and electrical generators are shown and described herein in use with a respective module, those skilled in the art will recognize that the present invention is not necessarily limited to the embodiments and/or combinations described herein.

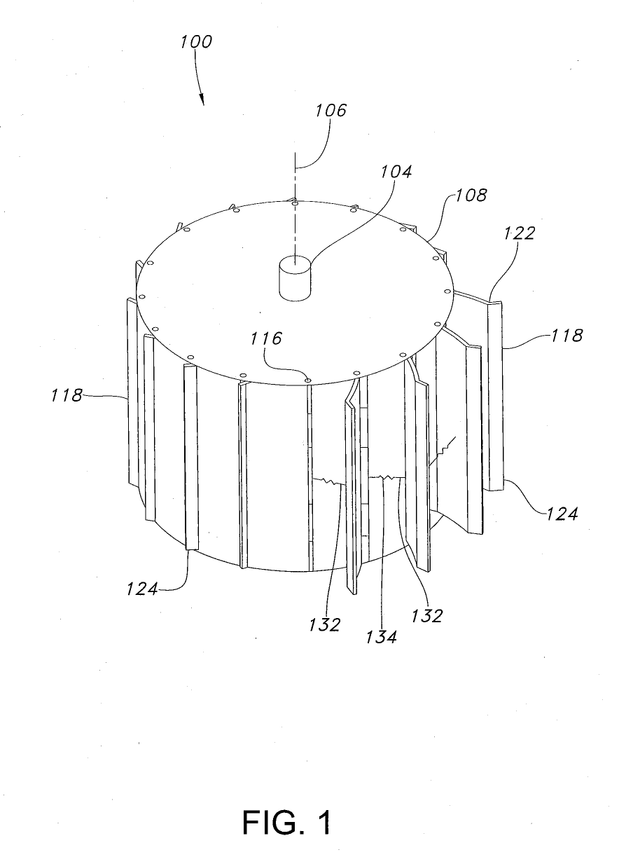

Referring to FIGS. 1-3, a water turbine 100 according to a first exemplary embodiment of the present invention is disclosed. Water turbine 100 includes a rotatable body 102, having a central hub portion 104. Hub portion 104 rotates about a central axis 106. A top cover 108 is disposed over body 102. A bottom cover (not shown) generally mirrors top cover 108.

In the embodiment shown in FIGS. 1-3, central axis 106 is a generally vertical axis. Those skilled in the art, however, will recognize that central axis 106 may alternatively be a horizontal axis or may extend at any angle between horizontal and vertical.

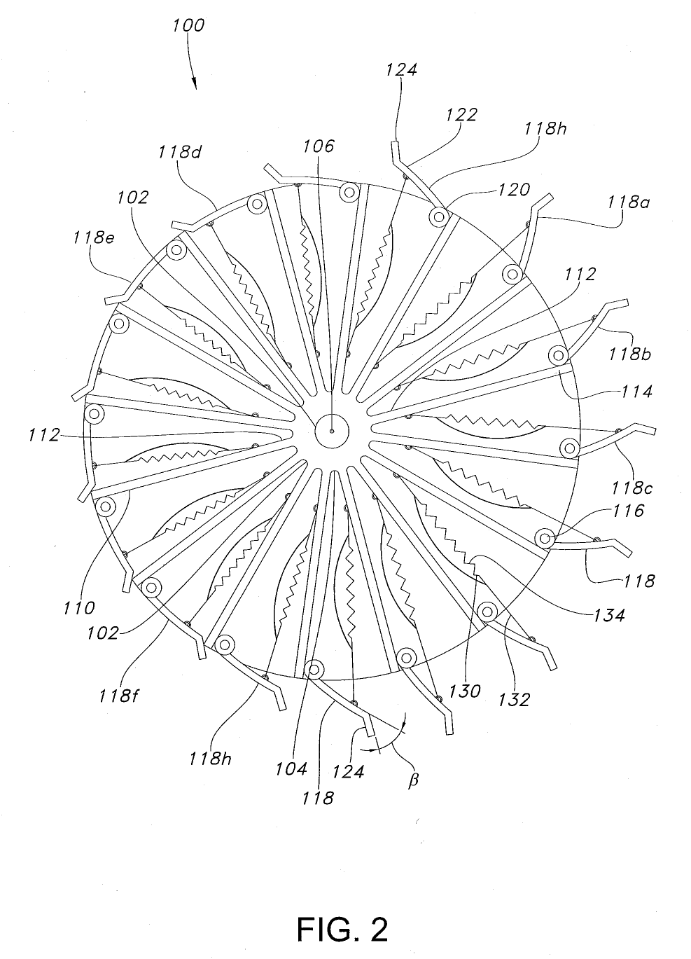

A plurality of spoke panels 110 extends radially outwardly from hub portion 104. Each spoke panel 110 includes a spoke panel coupled end 112 that is coupled to body 102 at central hub portion 104 and a spoke panel free end 114 that extends radially away from central axis 106. As shown in FIG. 2, sixteen (16) spoke panels 110 may be equally spaced around hub portion 104. Those skilled in the art, however, will recognize that more or less than 16 spoke panels 110 may be used. A hinge member 116 pivotally couples each spoke panel free end 114 to a gate 118. Gate 118 extends from the spoke panel free end 114 of each spoke panel 110. Each gate 118 includes a gate coupled end 120 that is pivotally coupled to spoke panel free end 114 and a gate free end 122. Hinge member 116 includes a hinge pin 117 that extends through spoke panel free end 114 and gate coupled end 120. A hinge bearing 121 may separate spoke panel free end 114 and gate coupled end 120. Such a hinge bearing may be constructed from a polymer or polymer composite to eliminate the need to lubricate hinge member 116.

Gate 118 pivots on hinge member 116 about spoke panel free end 114 between an open position and a closed position where a gate free end 122 is in releasable engagement with an adjacent spoke panel 110. Each gate free end 122 includes a gate lip 124 that extends obliquely away from gate free end 122. In an exemplary embodiment, gate lip 124 extends at an angle β of approximately 30°, although those skilled in the art will recognize that angle β may be more or less than 30°. Angle β assures that flowing water that impacts gate lip 124 begins to open gate 118.

Each gate 118 comprises a generally arcuate cross section, such that when gate 118 is in the closed position, gate 118 forms a part of a perimeter of a circle that has a radius extending from central axis 106 to spoke panel free end 114. The arcuate cross section reduces water drag along gate 118 when gate 118 is in a closed position.

FIG. 2 shows gates 118a, 118b, and 118c in an exemplary fully opened position and gates 118d, 118e, and 118f in a closed position. Gate 118g is shown in the process of moving from the closed position to the open position and gate 118h is shown moving from the open position to the closed position.

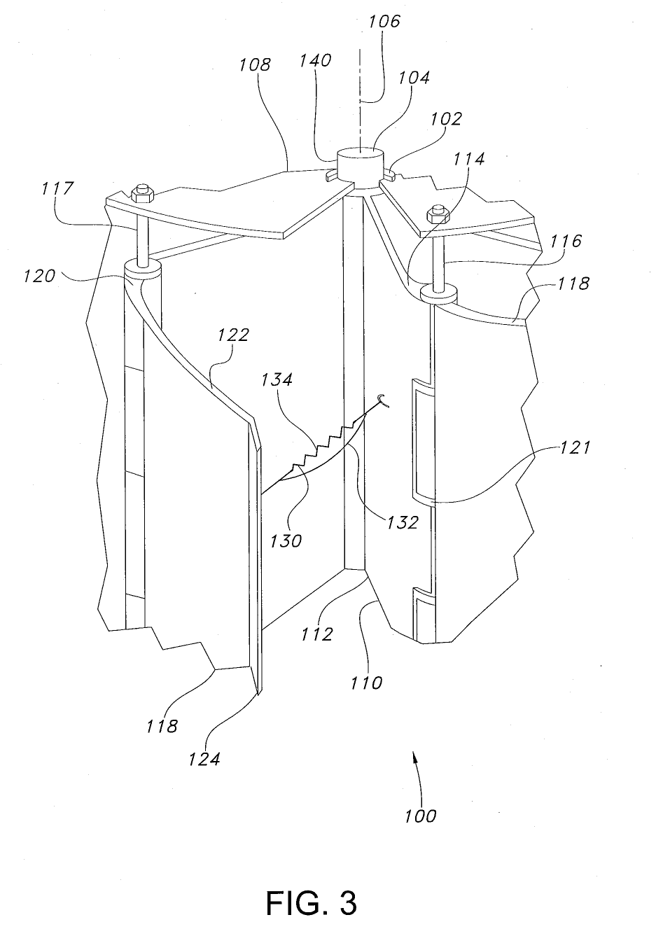

A dampening member 130 couples each gate 118 to an adjacent spoke panel 110, as shown in FIGS. 2 and 3. Each dampening member 130 includes a chain or cable 132 that couples gate 118 to adjacent spoke panel 110. When cable 115 is fully extended, cable 115 stops the travel of gate 118 to its fully opened position. In order to reduce the shock of rapidly stopping gate 118, a strong dampening member, such as a helical spring 134, is installed on cable 132 with a pre-determined cable slack between either end of spring 134 where spring 134 is coupled to cable 132. As gate 118 opens, the initial travel of gate 118 is unrestricted until gate 118 stretches all of the free travel of cable 132. Spring 134 then begins to extend, allowing spring 134 to decelerate gate 118, reducing the shock before cable 132 is fully extended and the travel of gate 118 is stopped at its full open position.

Hub portion 104 includes a shaft 140 that extends along central axis 106. Shaft 140 rotates with body 102 and transmits energy generated by turbine 100 to another device, such as an electrical generator (not shown in FIGS. 1-3). Shaft 140 may be connected to the electrical generator through conventional means, such as a gear box, belt, or a coupling. Shaft 140 may be mounted on a shaft bearing (not shown). Such a shaft bearing may be constructed from a polymer or polymer composite to eliminate the need to lubricate shaft 140.

In operation, turbine 100 is fully immersed in a body of water, such as a flowing stream or an ocean current. Turbine 100 may be manufactured of reinforced carbon fiber composite with surface corrosion protection to protect turbine 100 from its operating environment. The size of turbine 100 may be tailored according to its installation location. For example, the diameter and length of turbine 100 may be varied to conform to its specific stream width and depth, as well as a required energy output. In operation, the force of the current of the water in which turbine 100 is placed acts on gates 118 and spoke panels 110 to provide power to rotate turbine 100 about its central axis 106. As turbine 100 rotates, gate lip 124 is directly exposed to the flowing current. The force of the current engages lip 124, which in turn opens and exposes gate 118 to the current. The current then pushes gate 118 to its full open position.

As gate 118 moves from its closed to its open position, cable 132 extends. As gate 118 approaches its fully opened position, spring 134 begins to stretch, decelerating gate 118 and reducing the shock of stopping gate 118 in its fully opened position. The current forces against open gate 118 and its associated spoke panel 100, imparting a rotary motion to turbine 100. As turbine 100 rotates, each adjacent gate lip 124 is sequentially exposed to the water current, repeating the process described above.

As turbine 100 continues to rotate gate 118 beyond its exposure to the direct current flow, the forces applied to that particular gate 118 and its respective spoke panel 110 diminish. Gate 118 and its gate lip 124 pass through standing water, which imparts resistance, resulting in gate 118 beginning to close. Spring 134 also imparts a closing force on gate 118 to assist in closing gate 118 as turbine 100 rotates gate 118 to its passive position.

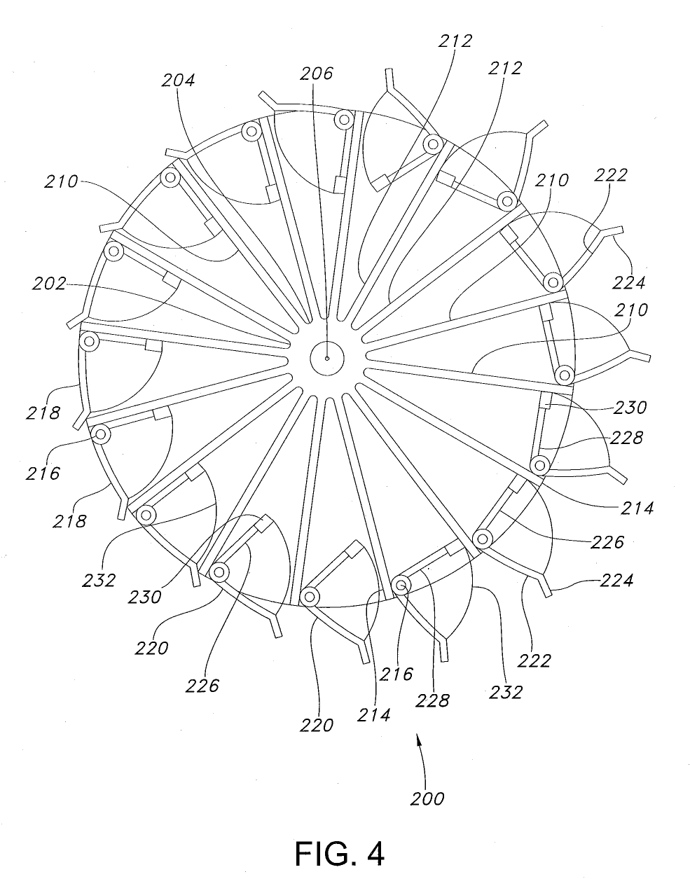

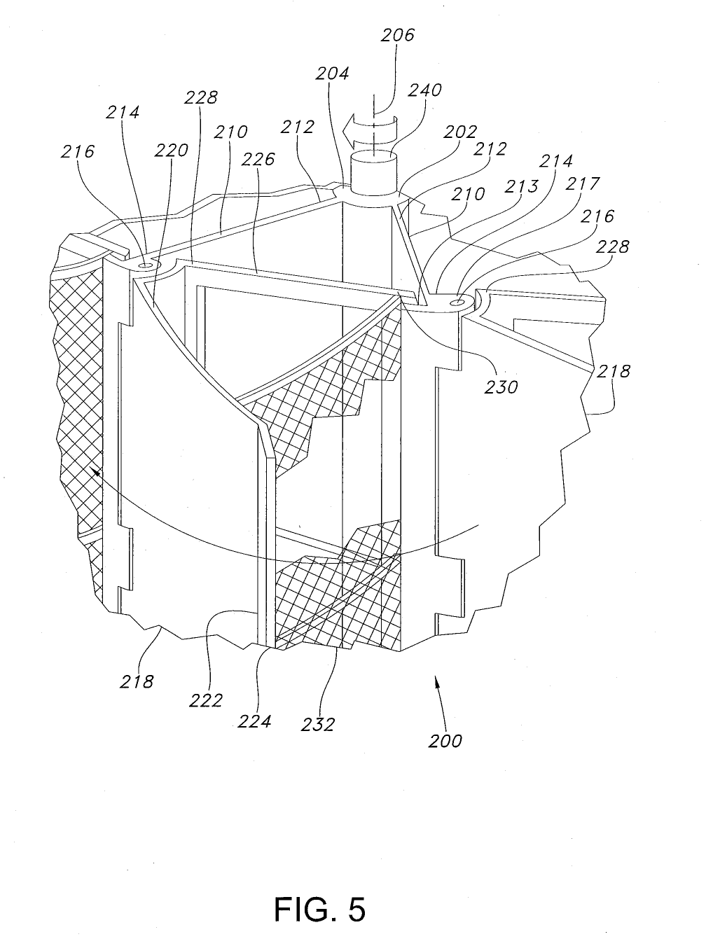

A second embodiment of a water turbine 200 according to the present invention is shown in FIGS. 4 and 5. Water turbine 200 is similar to water turbine 100, but with a different gate configuration. Turbine 200 includes a rotatable body 202, having a central hub portion 204. Hub portion 204 rotates about a central axis 206. In the embodiment shown in FIGS. 4 and 5, central axis 206 is a generally vertical axis. Those skilled in the art, however, will recognize that central axis 206 may alternatively be a horizontal axis or may extend at any angle between horizontal and vertical.

A plurality of spoke panels 210 extends radially outwardly from hub portion 204. Each spoke panel 210 includes a spoke panel coupled end 212 that is coupled to body 202 at central hub portion 204 and a spoke panel-free end 214 that extends radially away from central axis 206. As shown in FIG. 4, sixteen (16) spoke panels 210 may be equally spaced around hub portion 204. Those skilled in the art, however, will recognize that more or less than 16 spoke panels 210 may be used. A hinge member 216 pivotally couples each spoke panel free end 214 to a gate 218. Gate 218 extends from the spoke panel free end 214 of each spoke panel 110. Each gate 218 includes a gate coupled end 220 that is pivotally coupled to spoke panel free end 214 and a gate free end 222. Hinge member 216 includes a hinge pin 217 that extends through spoke panel free end 214 and gate coupled end 220.

Gate 218 pivots on hinge member 216 about spoke panel free end 214 between an open position and a closed position where a gate free end 222 is in releasable engagement with an adjacent spoke panel 210. Each gate free end 222 includes a gate lip 224 that extends obliquely away from gate free end 222. In an exemplary embodiment, gate lip 224 extends at an angle β of approximately 30°, although those skilled in the art will recognize that angle β may be more or less than 30° in order to open gate 118 as swiftly as possible when gate 118 is in the path of the flowing fluid, as well as to generate sufficient drag to close gate 118 as swiftly as possible when gate 118 is out of the flow path. An exemplary range of β may be 30°+/−5°.

Each gate 218 comprises a generally arcuate cross section, such that when gate 218 is in the closed position, gate 218 forms a part of a perimeter of a circle that has a radius extending from central axis 206 to spoke panel free end 214.

Gate 218 includes a rear gate portion 226 that includes a rear gate coupled end 228 fixedly coupled to gate coupled end 220 and a rear gate free end 230. Rear gate free end 230 is in releasable engagement with adjacent spoke panel 210 when gate free end 222 is in the open position.

A filter, such as a screen 232, extends between gate free end 222 and rear gate free end 230. Screen 232 prevents debris, including fish, from entering into the space between adjacent spoke panels 210. Screen 232 may include a mesh of sufficient size similar to other screen meshes for aquatic use to prevent debris of a predetermined size from passing through the mesh.

Spoke panel free end 214 includes a stopper 213 that extends slightly along the perimeter of turbine 100 and away from hinge member 216. Stopper 213 is used to engage rear gate free end 230 of an adjacent rear gate portion 226, as shown in FIG. 5, to stop gate 218 once gate 218 has reached its fully opened position. Although not shown in FIGS. 4-5, turbine 200 may employ the same or an alternative dampening member as turbine 100 discussed above, such as dampening member 130, to decelerate gate 218 as gate 218 approaches its fully opened position.

Water turbine 200 operates in a similar method to turbine 100 described above, with the flow of water engaging gate lip 224 and opening gate 218. The flow current forces against gate 218 and spoke panel 210 to rotate turbine 200.

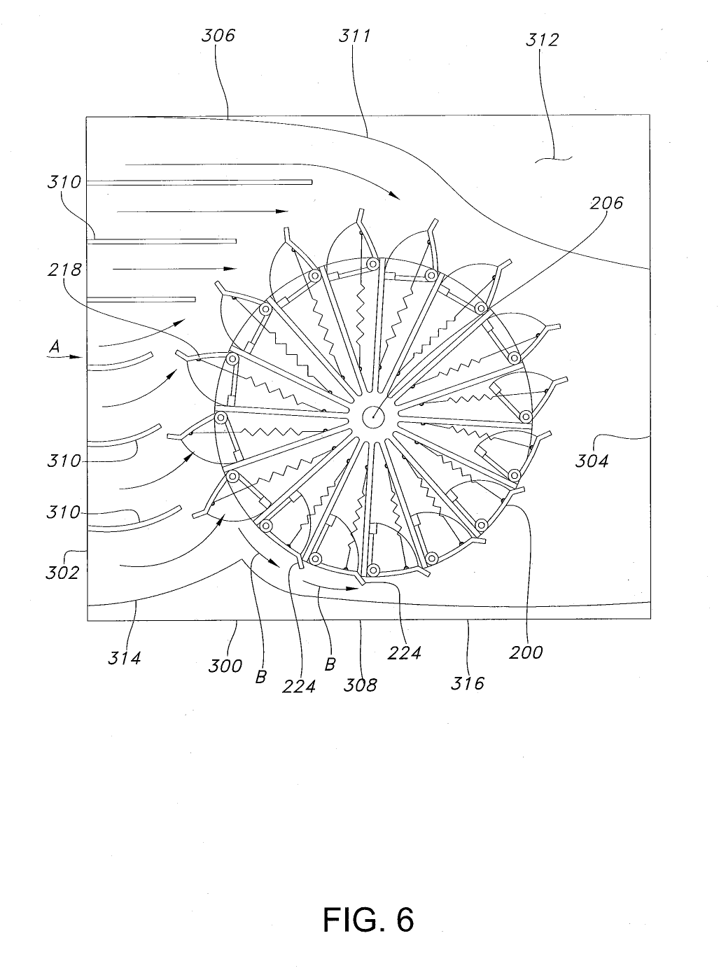

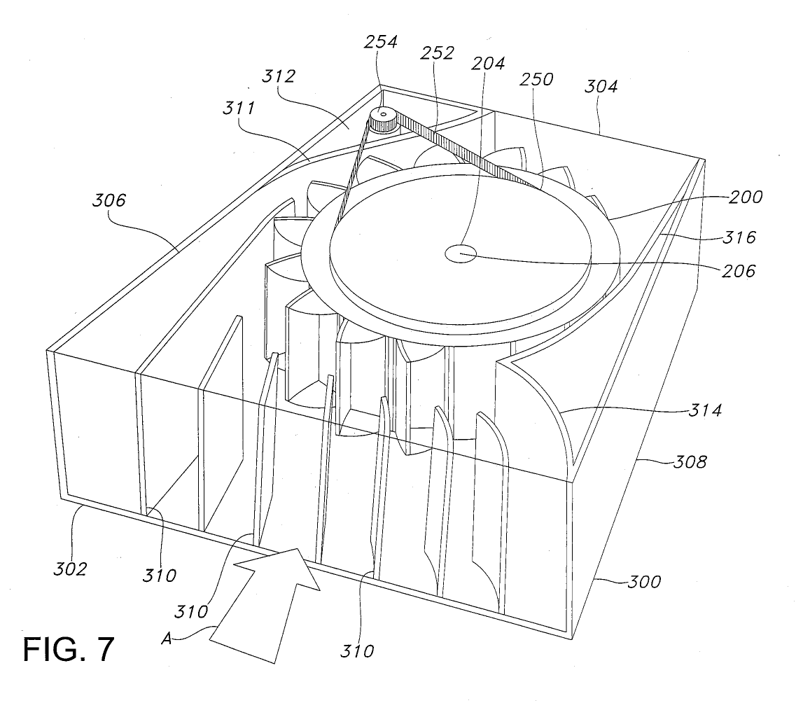

Referring now to FIGS. 6 and 7, a turbine module 300 that is used to house either of turbines 100 or 200 is disclosed. Turbine 200 is shown installed in module 300 in FIGS. 6-7. Both module 300 and turbine 200 are shown without top covers for illustrative purposes only. Module 300 may be sized and shaped similar to a known shipping container to facilitate manufacture and transport of module 300 using known shipping container methods.

Module 300 consists of a compartment with a generally fully open inlet end 302 and an outlet end 304 that has a cross sectional area generally less than the cross sectional area of inlet end 302.

A first side 306 extends between inlet end 302 and outlet end 304. A second side 308, which is disposed away from first side 306, also extends between inlet end 302 and outlet end 304. A plurality of directional vanes 310 extend inwardly from inlet end 302. Directional vanes 310 direct fluid, such as water flow, from inlet end 302, through module 300. Directional vanes 310 are angled to direct the fluid toward one side of central axis 206 of turbine 200. Vanes 310 may be angled to direct water flow at an angle determined to be most efficient for opening gates 218 and generating an optimum amount of power from turbine 200.

As shown in FIG. 6, directional vanes 310 direct fluid flow, shown as arrow “A” above axis 206. In doing so, fluid flow engages gates 218, opening gates 218 and rotating turbine 200 about axis 206 in a clockwise direction as shown in FIG. 6.

First side 306 curves into the interior portion of module 300 at a location approximately half way between inlet end 302 and outlet end 304. A sealed generator compartment 312 may be formed between first side 306 and compartment wall 311. Alternatively, generator compartment 312 may be omitted, with a generator located in a separate module. Compartment wall 311 is generally curved to provide a smooth transition of water flow along compartment wall 311 from inlet end 302 to outlet end 304.

Second side 308 includes a first curved wall portion 314 that curves into the interior module 300 toward turbine 200. First curved wall portion 314 ends a predetermined distance away from turbine 200. A second curved wall portion 316 extends away from first curved wall portion 314 such that an interface between first curved wall portion 314 and second curved wall portion 316 ends at a point. Second curved wall portion 316 extends toward outlet end 304 such that second curved wall portion 316 extends generally parallel to outer perimeter of turbine 200 until second curved wall portion 316 becomes generally parallel with second side 308. Second curved wall 316 then becomes generally straight and parallel to second side 308 until second curved wall portion 316 reaches outlet end 304. Outlet end 304 of module 300 may include a mesh screen (not shown) to prevent marine life from entering module 300 from outlet end 304.

As shown in FIG. 7, if a generator is located within compartment 312, a belt wheel 250 may be coupled to hub portion 204 of turbine 200. A drive belt 252 couples belt wheel 250 to an input wheel 254 of a driven device, such as an electrical generator (not shown). Alternatively, drive belt 252 may couple belt wheel 250 to a device located in a separate module.

While FIG. 7 is shown without a covering, those skilled in the art will recognize that a covering is disposed over module 300 such that turbine 200 is within module 300, while belt wheel 250 is outside of module 300. Hub portion 204 of turbine 200 extends through cover of module 300.

Directional vanes 310 direct the majority of fluid entering inlet end 302 of module 300 to open gates 218 that are exposed to fluid that is redirected by directional vanes 310. A small portion of the fluid, however, may be able to flow between second curved wall portion 316 and outer perimeter turbine 200 along arrows “B” shown in FIG. 6. This flow engages gate lips 224 on gates 218, maintaining gates 218 in the closed position.

It is believed that a maximum velocity of the fluid flow a through module 300 is located between gate lip 224 of an open gate 218 where the distance between gate lip 224 and the compartment wall 311 is at a minimum.

Directional vanes 310 generate a generally tangential flow of the fluid along the perimeter of turbine 200. This tangential flow reduces flow impact on gates 218 and result in energy losses in heat. By forcing the current flow through the minimum area, or throat, between turbine 200 and compartment wall 311, the inlet pressure of the fluid is increased, which accelerates the flow driving turbine 200. The tangential flow being directed at the throat accelerates the flow discharge downstream of the throat and aids at reducing outlet pressure rapidly. The overall effect of this flow design significantly increases the operational performance of turbine 200 enhancing the efficiency of turbine 200.

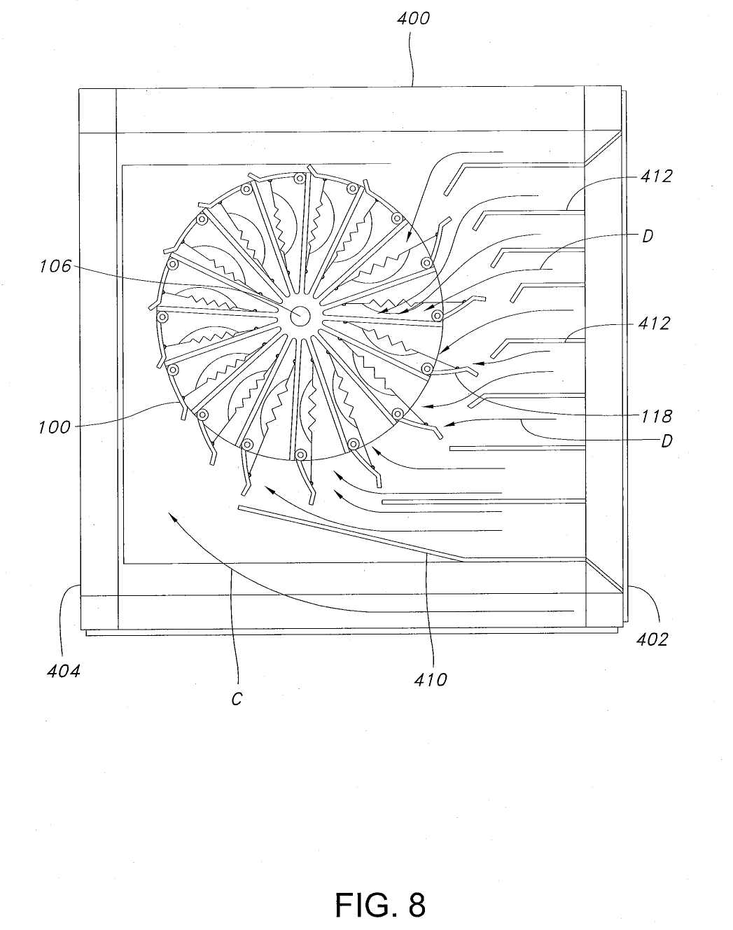

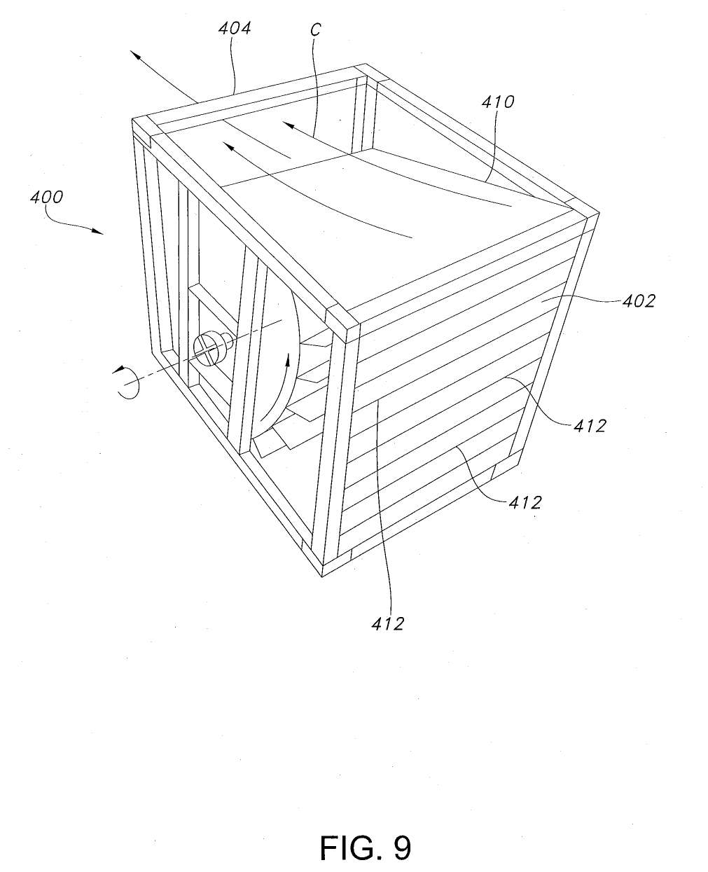

An alternative embodiment of a module 400 for housing a turbine, such as turbine 100 or turbine 200, is shown in FIGS. 8-9. Turbine 100 is used as the exemplary turbine in FIGS. 8-9. Module 400 includes an inlet end 402 and an outlet end 404. Turbine 100 is disposed within a space between inlet end 402 and outlet end 404. In this embodiment, turbine 100 is shown with axis 106 extending generally horizontally. FIG. 8 is shown with a side wall removed.

Modules 400 includes an upper plate 410 that allows fluid to flow over turbine 100 and to rear of turbine 100, between turbine 100 and outlet end 404 of module 400. Such flow is shown as arrow “C” and is generally tangential to the outer perimeter of turbine 100. Such flow reduces the pressure of the fluid immediately between turbine 100 and outlet end 404 of module 400. Upper plate 410 may be transparent or include a transparent portion to allow a technician to view inside module 400 during operation to confirm proper operation of turbine 100 within module 400.

Module 400 also includes a directional vanes 412 extending inward into module 400 from inlet end 402. Directional vanes 412 direct the flow of fluid for turbine 100 as shown in arrows “D” in FIG. 8.

As can be seen from FIG. 8, approximately 6 of the 16 gates 118 on turbine 100 are shown in a full or nearly full open position. It is desired that, for a turbine with 16 gates, between about 5 and about 7 gates 118 are in a full open or near full open position at any one times. In an exemplary embodiment, gates 118 may each have a width of about 6.375 feet (about 1.94 m) and a height of about 3.520 feet (about 1.07 meters). For a turbine 100 having 6 fully open gates 118, a total effective surface area of about 134.64 square feet (about 12.45 square meters) may be provided.

When an open gate 118 is rotated toward a downstream side of turbine 100, dampening member 130 begins to pull gate 118 to its closed position. Low water pressure on the downstream side of turbine 100 and water drag acting on gate 118 assist in closing gate 118 as gate 118 approaches the downstream end 404 of module 400.

As shown in FIG. 8, directional vanes 412 are generally straight or straight with angled edge portions, while module 300 shown in FIG. 6, shows generally curved directional vanes 310. Those skilled in the art will recognize that either vanes 310 or 412 may be used in either module 300 or module 400, or a combination of directional vanes 310 or directional vanes 412 or some other configuration of directional vanes may be used. The intent of directional vanes 310 and directional vanes 412 is to direct the flow of water at the inlet at each respective module 300, 400 to engage gate lips 124, 224 in order to open gates 118, 218. Such action exposes as much surface area of gates 118, 218 and their respective spoke panels 110, 210 to the flowing water as possible.

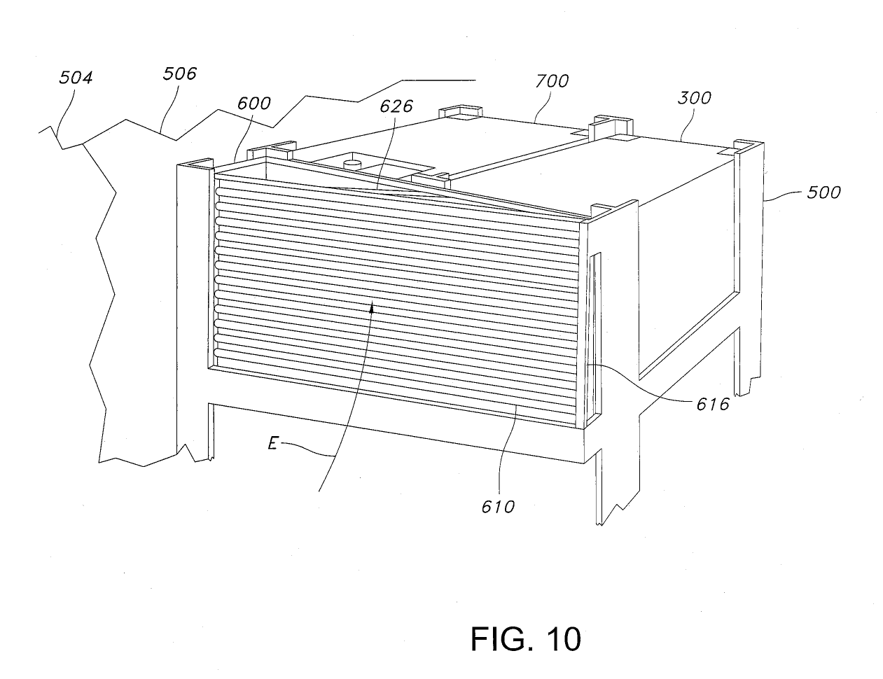

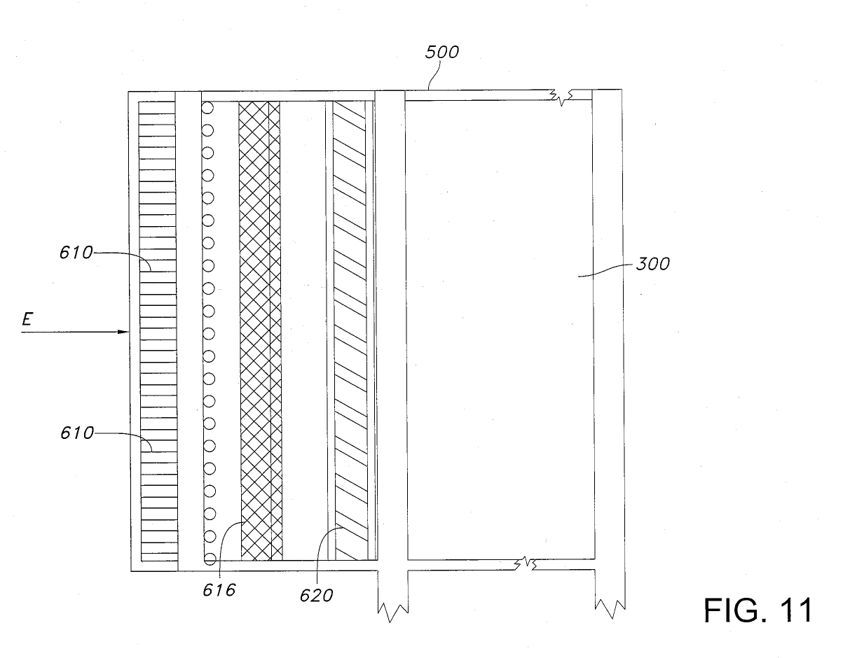

Referring now to FIGS. 10-11, a stationary electrical generation station that may incorporate either of turbines 100, 200 and/or turbine modules 300, 400 as discussed above is disclosed. As shown in the figures, turbine module 300 is used as an exemplary turbine module. Station 500 modularly retains turbine module 300, an inlet flow module 600, and a power generation module 700. Turbine module 300, inlet flow module 600, and a power generation module 700, are all modularly coupled to station 500 such that turbine module 300, inlet flow module 600, and a power generation module 700, may be separately removed from station 500 for repair and/or replacement with a minimum loss of energy production time.

Station 500 includes a metal framework 502. Framework 502 is designed to be installed in a river/stream bed 504 and submerged below the water line 506. Station 500 may be constructed from angle and “T” members. Inlet flow module 600 may be located in an upstream portion of station 500 with turbine module 300 and power generation module 700 side by side each other, downstream of inlet flow module 600.

Station 500 allows turbine modules 300, inlet flow module 600 and or power generation module 700 to be removed from station 500 without moving station 500, simply by decoupling each of turbine module 300, inlet flow module 600, and power generation module 700 from each other, and vertically lifting the desired module from station 500.

While turbine module 300 or 400 as disclosed above may be used with station 500, those skilled in the art will recognize that other modules that house turbines similar to other known turbines, such as Davis or Darrieus turbines, or ducted or unducted multi-bladed axial flow turbines similar to the Verdant turbine, or still alternatively, turbine design similar to the Gorlov helical turbine, may be used in turbine module 300 and may include multiple turbines grouped within a single module. These turbines may includes an integral generator, gear box, electrical cables, and connectors that permit rapid removal and replacement of module 300, 400.

Still referring to FIGS. 10 and 11, inlet flow module 600 includes an upstream or inlet side that includes a debris guard 610 as shown in the exemplary embodiments shown in FIGS. 10 and 11, debris guard 610 may be constructed from horizontal members, those skilled in the art will recognize that debris guard 610 may also be constructed from vertical members and/or members that extend obliquely relative to either the horizontal or the vertical. Further, while debris guard is shown as a plurality of cylindrical members, those skilled in the art will also recognize that the members that comprise the debris guard 610 may also be constructed from other shapes such as angle members.

Immediately downstream from the debris guard, a fish screen 616 is installed to protect fish from entering turbine module 300. Fish screen 616 may be angled relative to the direction of water current, shown as arrow “E” in FIG. 10, in order to urge any fish away from turbine module 300.

A set of inlet flow module louvers 620 are disposed immediately downstream of fish screen 616. Louvers 620 are adjustably operated via a pneumatic control system (not shown in FIG. 10) that is situated in power generation module 700. Louvers 620 control water flow into turbine module 300 in accordance with system requirements. Additionally, louvers 620 fail to a close position in the event of a system error within either turbine module 300 or power generation module 700 in order to reduce the flow of fluid through turbine module 300.

Inlet flow module 600 further includes a flow diverter panel 626 that diverts currents from the upstream and of station 500 away from power generation module 700 and toward turbine module 300.

Debris guard 610, fish screen 616, louvers 620, flow diverter panel 626 are mounted in a framework 630. Framework 630 may be removed from station 500 for maintenance and or replacement of inlet flow module 600.

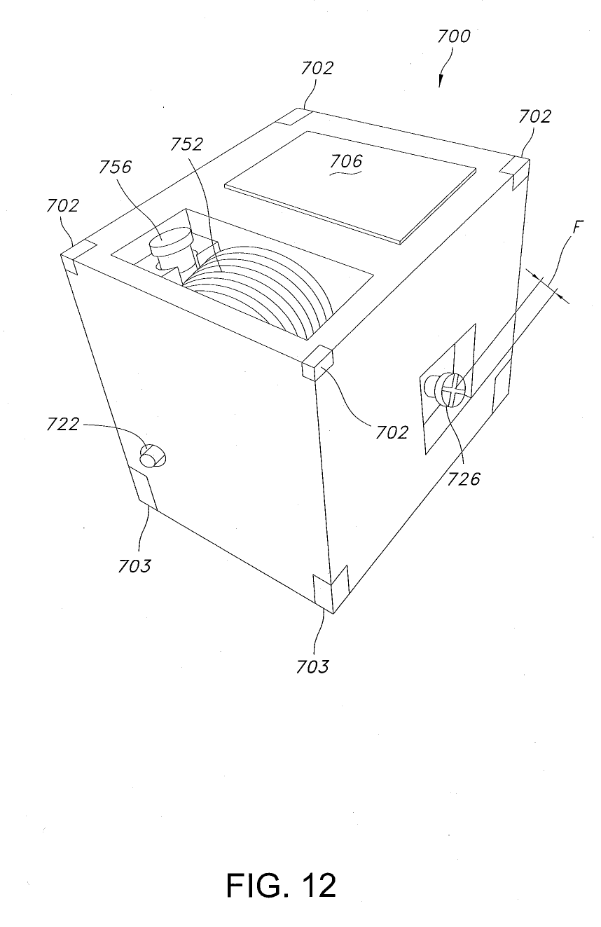

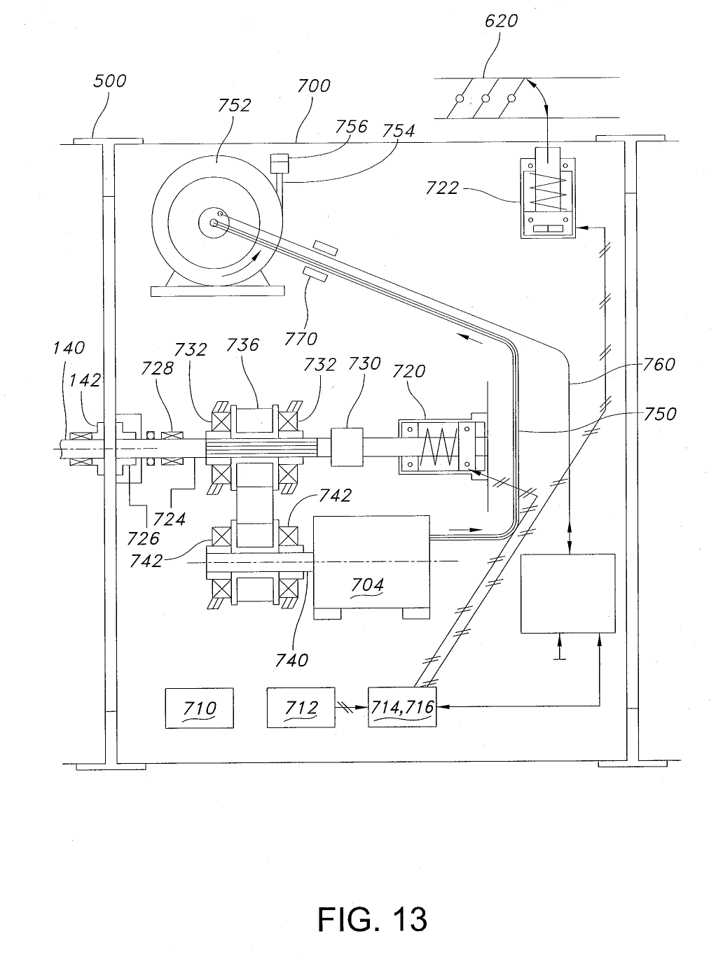

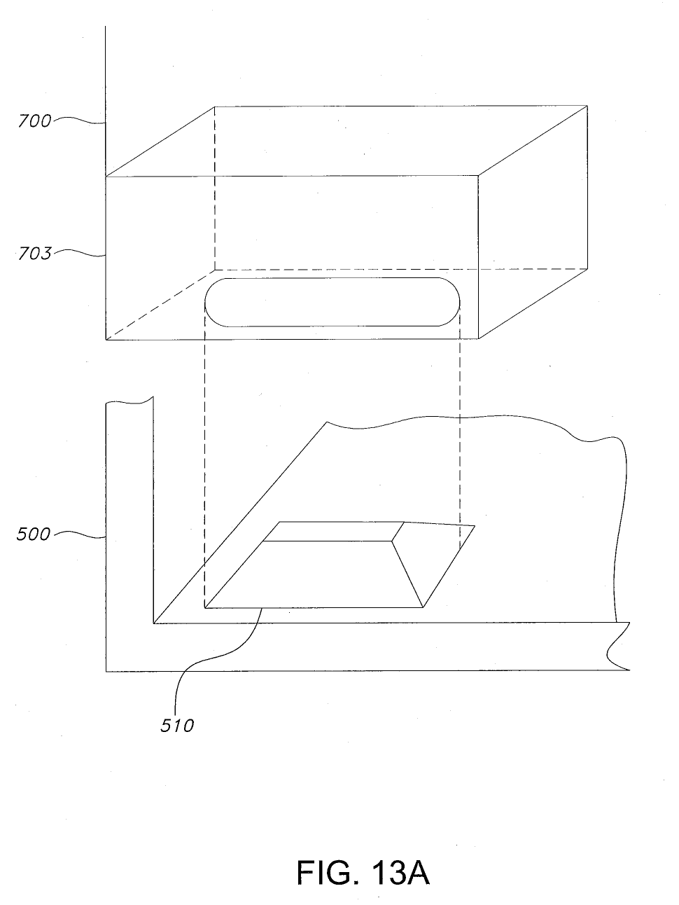

Power generation module 700 is shown in a perspective view in FIG. 12 and schematically in FIG. 13. Power generation module 700 includes a generator that absorbs power generated by turbine 100, 200 for conversion into electrical energy. The electrical energy may be alternating current or direct current, depending upon the intended use of the generated electricity, as well as the projected transmission distance of the generated electricity. The generator used in power generation module 700 may be any conventional generator. Power generation module 700 includes lift fittings 702 that enable power generation module 700 to be lifted from a receptacle, such as station 500. Power generation module 700 also includes locating fittings 703 on bottom corners of module 700. Locating fittings 703 are female fittings that mate to a matching male fitting 510, shown in FIG. 13A, on base of system 500.

To ensure proper alignment of turbine module 300 with power generation module 700, a sensor, such as a light pipe (not shown), may be used to transmit a light from one of turbine module 300 and power generation module 700 to the other of turbine module 300 and power generation module 700. When modules 300, 700 are aligned, as sensor in the other of turbine module 300 and power generation module 700 senses the light and transmits a signal to an indicator (not shown).

An electrical generator 704 may be housed in a water tight compartment 706. In addition to housing electrical generator 704, water tight compartment 706 may also include a controller 708, a back up battery 710, an air compressor 712, an electric pneumatic valves 714, 716. Compartment 706 also includes a shaft pneumatic actuator 720 and a louver actuator 722. Shaft pneumatic actuator 720 is used to engage and disengage electrical generator 704 with turbine 100, 200. Louver pneumatic actuator 722 is used to operate louvers 620 on inlet flow module 600.

Shaft pneumatic actuator 720 is used to engage and/or disengage a shaft assembly 724 from shaft 140 on turbine 100. Shaft assembly 724 includes a coupling 726 that directly engages a mating coupling 142 on turbine shaft 140. Coupling 726 is coupled to an elongated shaft 728 that is coupled to shaft pneumatic actuator 720 via a coupling 730. A portion of shaft 728 between coupling 726 and 730 splined, as shown in FIG. 13. Splined portion of shaft 728 may be supported by a pair of bearings 732 that are disposed on either side of a speed increasing drive belt 736. An additional bearing 738 may support shaft 728 between splined section and coupling 726.

Drive belt 736 is coupled to an input shaft 740 that drives electrical generator 704. Input shaft 740 may be supported by a pair of bearings 742 on either side of drive belt 736. While electrical generator 704 is shown as being driven by a speed increaser, those skilled in the art will recognize that electrical generator 704 may be a direct drive generator.

Electrical power generated by electrical generator 704 is transmitted from power generation module 700 via an electrical cable 750 that extends from electrical generator 704 through a self rewinding cable reel 752 to a flexible cable 754, which terminates in an electrical quick disconnect coupling 756.

Battery 710 operates controller 708 and monitors all necessary functions of power generation module 700 including rpm of electrical generator 704, power produced from electrical generator 704, temperatures within power generation module 700, water intrusion within power generation module 700, interlocks, switch gear operation, and sensors. Data obtained and or generated by controller 708 may be transmitted to a remote operator via a controller cable 760 that couples to cable reel 752 for output to quick disconnect coupling 756 via flexible cable 754. Quick disconnect coupling 756 may be coupled to a receiver coupling (not shown) for transmitting electrical power generated by electrical generator 704 and signals generated by controller 708 to a land based site.

Air compressor 712 supplies air pressure to shaft pneumatic actuator 720 which, when activated, extends shaft assembly 724 a distance “F”, shown in FIG. 12. When actuator 720 is in an “OFF” condition, shaft 724 is retracted, disengaging to shaft coupling 726 from mating coupling 142 of turbine 100 as shown in FIG. 13. When actuator 720 is in the “ON” position, shaft 724 is driven to the left as shown in FIG. 13 so that shaft coupling 726 engages mating coupling 142 on turbine 100.

Additionally, air compressor 712 operates louver pneumatic actuator 722 to adjust the position of louvers 620 on inlet flow module 600. Louver pneumatic actuator 722 can vary the angle of louvers 620 for desired fluid flow into turbine module 300.

Both shaft pneumatic actuator 720 and louver pneumatic actuator 722 are fail-safe so that, with loss of power, pneumatic actuators 720, 722 disconnect from mating coupling 142 and close louvers 620. Additionally, upon retraction of pneumatic actuators 720, 722, pneumatic actuator 720 retracts shaft coupling 726 into the perimeter of power generation module 700 and pneumatic actuator 722 retracts into power generation module 700, permitting rapid removal of power generation module 700 without mechanical interference with turbine module 300 and/or inlet flow module 600.

Power cable 750 and controller cable 760 extend from watertight compartment 706 through a watertight opening 770 into cable reel compartment 772, shown in FIG. 12. Electrical generator 704, shaft assembly 724, battery 710, air compressor 712, electro pneumatic valves 714, 716, controller 708, and pneumatic actuators 720, 722 are all contained within watertight compartment 706, insulating these components from water flow.

While power generation module 700 discloses shaft coupling 726 as having a horizontal shaft, those skilled in the art will recognize that shaft coupling 726 may extend vertically, such as from a bottom of power generation module 700, and couple to a turbine 100, 200 whose output shaft is also vertical. In such a configuration, turbine module 300, 400 may be submerged, with power generation module disposed vertically above turbine module 300, 400.

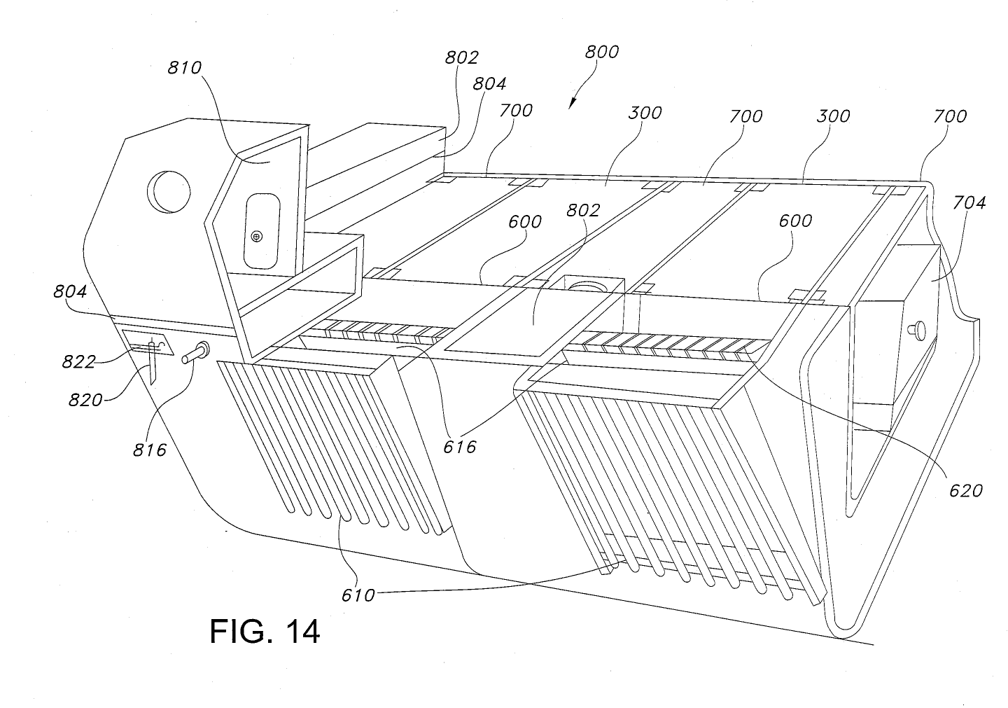

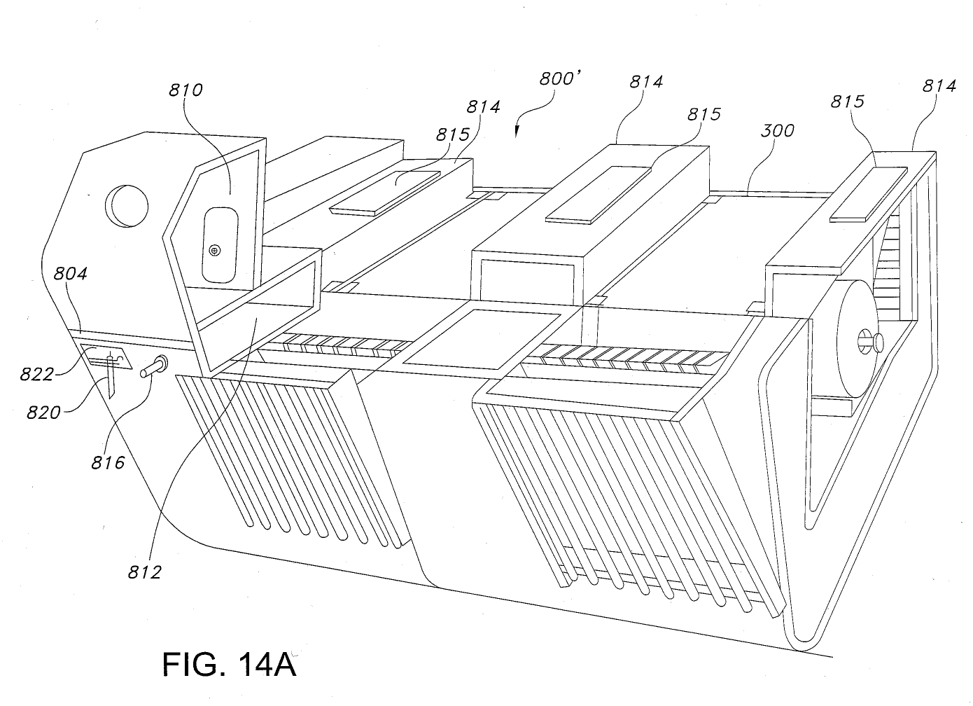

Referring now to FIG. 14, a barge 800 may be used to couple multiple turbines and generators together in a single system. Barge 800 may include a plurality of turbine modules 300 that alternate with power generation modules 700. In an exemplary embodiment, barge 800 may include fourteen (14) turbine modules 300. Inlet flow modules 600 are disposed upstream of each turbine module 300. As discussed above, each inlet flow module 600 may include a debris guard 610, a fish screen 616, and louvers 620 to protect a turbine (not shown in FIG. 14) disposed within module 300.

Barge 800 may also include ballast and trim tanks 802 that are used to submerge barge 802 such that turbine modules 300 are situated below a waterline 804 during operation. Stabilizers (not shown) may extend from barge 800 to further stabilize barge 800 after it is deployed.

In an exemplary embodiment, barge 800 may be fully submersible to operate at exemplary depths of between about 50 feet (about 15 meters) and about 200 feet (about 61 meters) below the water surface. Such depths may be required to take advantage of the fastest flow of a water current in a tidal or open sea environment. Barge 800 may be raised to the surface for maintenance.

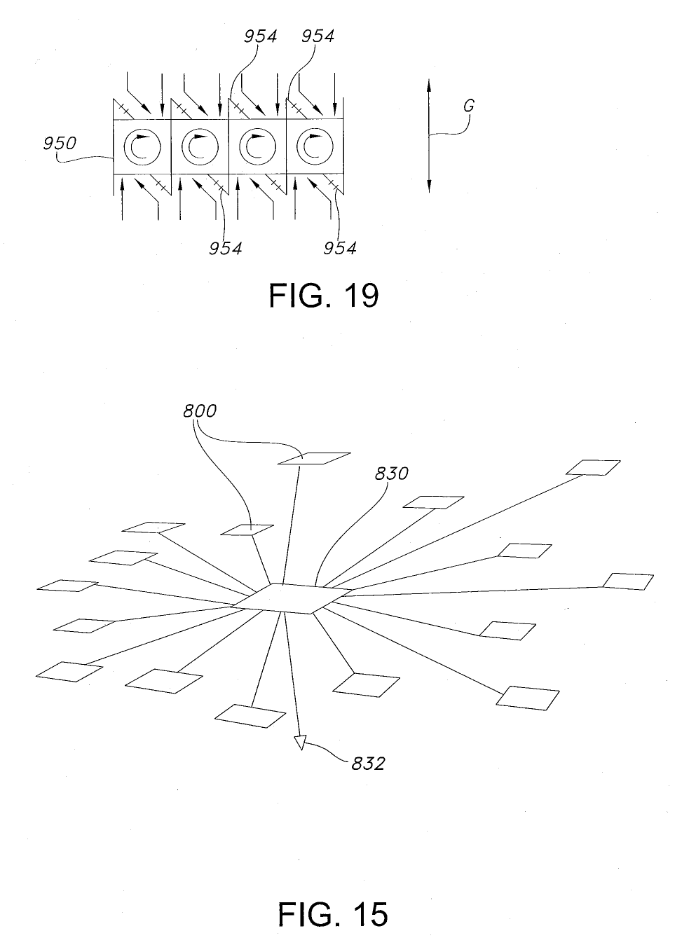

When barge 800 is on the water surface, barge 800 includes a maintenance area 810 that extends above the waterline. Maintenance area 810 is sufficiently large to allow a maintenance technician to stand in maintenance area 810. A sealed maintenance passage 812 contains auxiliary equipment, such as wiring, controls, air compressor, and backup batteries. Electrical power generated by generators 704 mounted in power generation modules 700 on barge 800 is conducted away from barge 800 via a power outlet cable 816 that extends through the hull of barge 800. As shown in FIG. 14, power outlet cable 816 is disposed below waterline 804, although those skilled in the art will recognize that power outlet cable 816 may alternatively be disposed above waterline 804. Power outlet cable 816 may also include signal cables (not shown) that are used to transmit operational data of barge 800 to a control vessel 830, shown in FIG. 15.

An alternative embodiment of barge 800 is shown in FIG. 14A as barge 800′. Barge 800′ is similar to barge 800, but includes permanent generator and control compartment 814 in the place of generator module 700. An access port 815 in the top of compartment 814 allows maintenance to be performed inside compartment 814 when barge 800′ is on the surface.

Barge 800′ may use standard turbine/generators (not shown) that may be located in turbine module 300. If so, output from such generators may be plugged into compartment 814 for further transmission from barge 800′.

Control vessel 830 may include connections from multiple barges 800, 800′. For simplicity, only barge 800 is shown in FIG. 15. For example, FIG. 15 shows sixteen (16) barges 800 coupled to a single control vessel 830. Control vessel 830 may combine and regulate the power produced by its associated barges 800. If each barge includes the exemplary 14 turbine modules 300, then a total of 224 turbine modules 300 may be controlled with control vessel 830. Control vessel 830 may then transmit the power from all of its connected barges 800 to a shore based power station 832 for further transmission of the generated power.

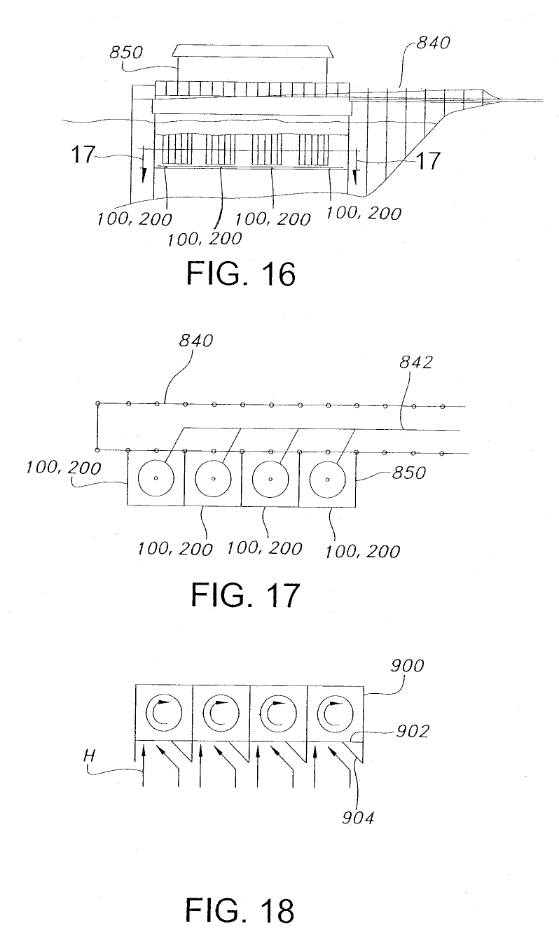

Barge 800 may be moored to a stationary location, such as in a river, or other suitable location, via mooring cables 820 coupled to mooring mounts 822 mounted on the hull of barge 800. In an alternative exemplary embodiment, shown in FIGS. 16 and 17, a floating barge 850 may be moored to a pier 840. In the exemplary embodiment shown, floating barge 850 includes four (4) turbines 100, 200. Electrical power generated by turbines 100, 200 is routed from floating barge 850 along pier 840 via power cable 842. An alternate embodiment of a turbine module that may be used for floating barge 850 is shown in FIG. 18, which provides a schematic of four (4) turbine modules 900 aligned next to each other. Inlet end 902 includes a flow concentrator 904 that directs fluid flow into module 900 as shown in FIG. 18. Module 900 may be installed in a river or stream where a current of fluid flow is always in the same direction (e.g. from inlet to outlet).

In an alternative embodiment of a series of turbine modules 950, shown in FIG. 19, floating barge 850 on which turbine modules 950 may be mounted is located in an area exposed to tidal flow as shown by arrow “G” in the figure.

Flow concentrators 954 are located on both the upstream and downstream ends of modules 950. Flow concentrators 954 include freely hinged doors 956 that are hinged to close upon impingement by water flow directed inward toward module 950 but to open outward upon impingement by flow from inside module 950. With this embodiment, turbine modules 950 operate regardless of the direction of fluid flow along either direction identified by arrow “G.”

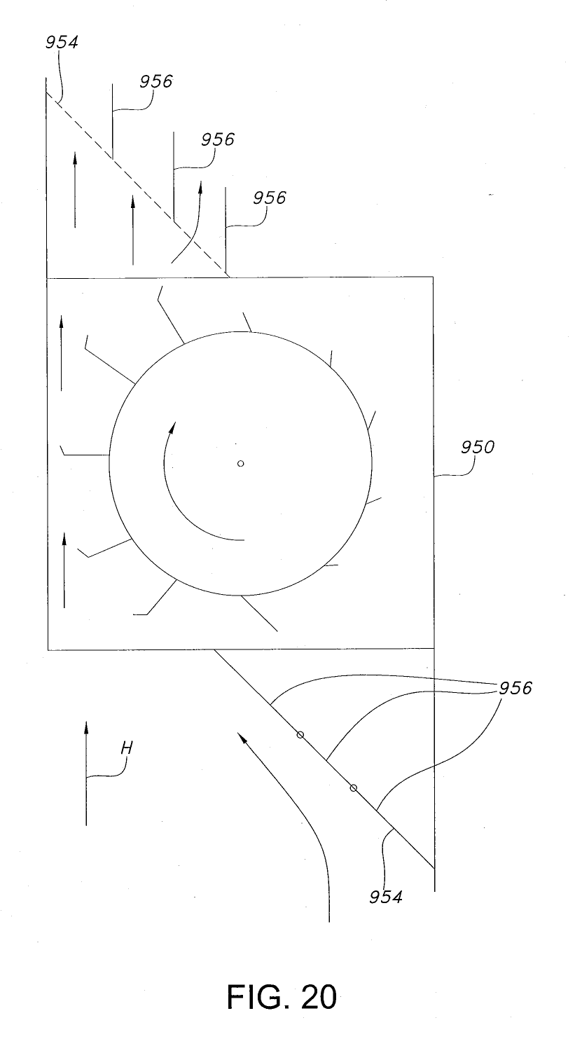

FIG. 20 shows an enlarged view of one of the turbine modules 950 of FIG. 19, with the water flow in the direction of arrow “H”. As shown in FIG. 20, doors 956 at the upstream end of module 950 are closed, and divert flow “H” to the left to enter module 950, while downstream doors 956 open to allow flow “H” to exit module 950.

While exemplary embodiments of turbine modules are shown in conjunction with floating barge 850, those skilled in the art will recognize that any turbine module disclosed herein may be incorporated into floating barge 850.

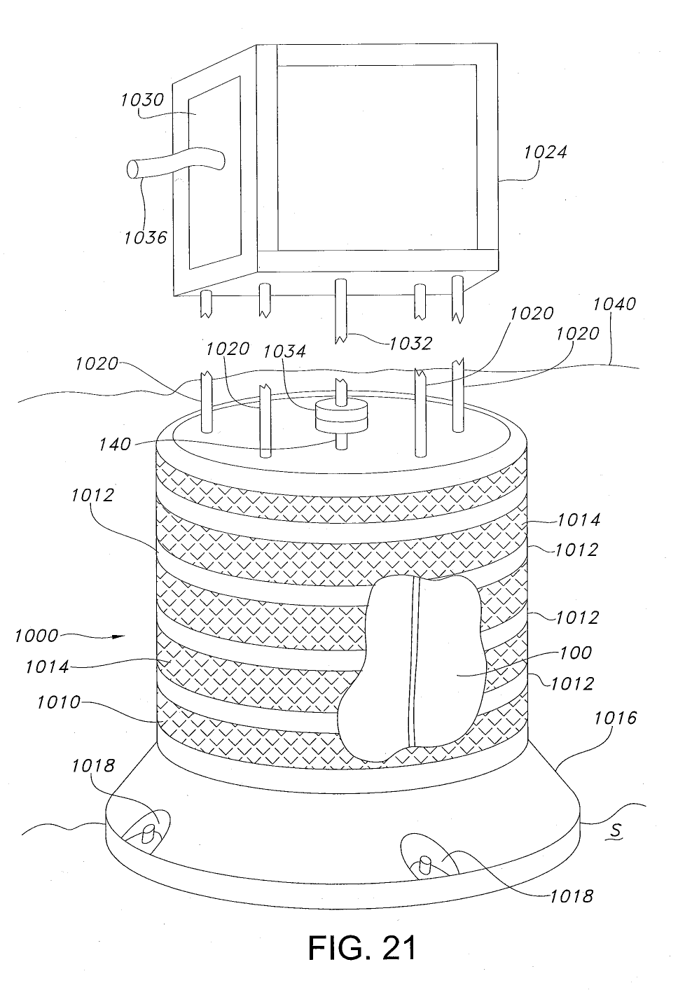

FIG. 21 shows an alternative embodiment of a turbine system 1000 that operates with a current regardless of current flow. Turbine system 1000 may be installed in a tidal inlet and provide power to a shore based distribution system, or even directly to one or more end-users.

Turbine system 1000 includes a turbine module 1010 that houses a water turbine, such as, but not limited to, turbine 100. Turbine module 1010 includes a debris guard 1012 and a fish screen 1014 that circumscribe turbine 100 to protect turbine 100 from damage. Turbine module 1010 includes a base 1016 that supports turbine module 1000 on a surface “S”, such as a riverbed or a tidal region floor. Base 1016 may include a plurality of cutouts 1018 peripherally spaced therearound that may be used to anchor turbine module 1000 to surface “S”.

Turbine module 1000 includes a plurality of support stanchions 1020 that extend from a top surface 1022 of turbine module 1000. Support stanchions 1020 support a generator cradle 1024. Generator cradle 1024 supports an electrical generator 1030 that is used to generate electricity from the rotation of turbine 100.

Generator 1030 is coupled to turbine 100 through a generator shaft 1032 that extends downward from generator 1030 toward turbine 100. Turbine 100 includes turbine shaft 140, which is releasably coupled to generator shaft 1032 via a coupling 1034. Electricity generated from generator 1030 is conducted to a distribution system (not shown) via an electrical cable 1036 that extends from generator 1030.

Turbine module 1010 is intended to remain under water level 1040 while generator 1030 is intended to remain above water level 1040. Turbine system 1000 may be used in a river, or in a tidal basin. Alternatively, although not shown, instead of coupling turbine 100 to generator 1030, turbine 100 can be coupled to another device, such as a pump, that may be used to pump water from turbine system 1000, such as for household use or irrigation.

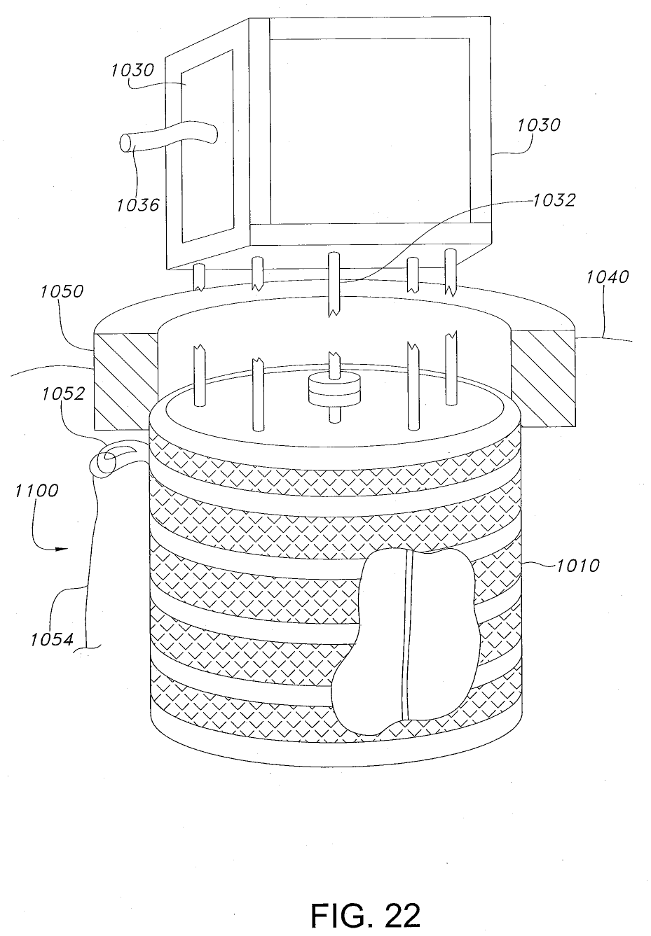

An alternative embodiment of a turbine system 1100 is shown in FIG. 22. Turbine system 1100 is similar to turbine system 1000 discussed above, but eliminates base 1016 and adds a flotation collar 1050 to turbine module 1010. Flotation collar 1050 may be constructed from an EPS foam fill. An exemplary EPS foam fill may be a Versafloat Deck provided Scottco Distributors, Inc. of Hayden, Id. Flotation collar 1050 allows turbine assembly 1100 to float on the surface of the water, such that turbine module 1010 remains below water level 1040 and generator 1030 extends above water level 1040.

Turbine system 1100 includes at lest one anchor loop 1052 that may be coupled to an anchor cable 1054 for securing turbine assembly 1100 to a predetermined location.

While turbine systems 1000, 1100 disclose turbine modules 1010, 1110, those skilled in the art will recognize that other turbine modules, such as, but not limited to, turbine modules 300, 400, 900, 950 may be used instead.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A water turbine comprising:
a rotatable body having a central hub portion;
a plurality of spoke panels, each of the plurality of spoke panels having:
a spoke panel coupled end coupled to the body at the central hub portion; and
a spoke panel free end extending radially away from the central axis; and
a plurality of gates, each of the plurality of gates having:
a gate coupled end pivotally coupled to the spoke panel free end of each of the plurality of spoke panels; and
a gate free end for pivoting movement between an open position and a closed position wherein the gate free end is in releasable engagement with an adjacent spoke panel,
each gate being independent of the remaining gates.

2. The water turbine according to claim 1, further comprising a biasing member coupling each of the plurality of gates to each of the plurality of spoke panels, wherein the biasing member biases the gate free end against the adjacent spoke panel.

3. The water turbine according to claim 1, wherein each of the gates comprises a generally actuate cross section.

4. The water turbine according to claim 1, wherein each gate free end comprises a gate lip extending obliquely away from the vane free end.

5. The water turbine according to claim 1, wherein each gate further comprises a rear gate portion having:
a rear gate portion coupled end fixedly coupled to the gate coupled end for pivoting movement between an open position and a closed position; and
a rear gate portion free end,
wherein the rear gate portion free end is in releasable engagement with the adjacent spoke panel when the gate free end is in the open position.

6. The water turbine according to claim 5, further comprising a filter extending between the gate free end and the rear gate portion free end.

7. The water turbine according to claim 5, further comprising stopping means for limiting pivoting of the gate with respect to the spoke panel.

8. The water turbine according to claim 5, wherein each rear gate portion comprises a gate opening providing fluid communication though a perimeter of the gate.

9. The water turbine according to claim 1, further comprising a dampening member coupling each of the plurality of gates to the adjacent spoke panel, wherein the dampening member decelerates the pivoting of the gate free end toward the open position.

10. The water turbine according to claim 9, wherein the dampening member biases the gate free end toward the closed position.

11. A water turbine module assembly comprising:
a housing comprising an inlet, an outlet, and a turbine compartment disposed between the inlet and the outlet;
a turbine disposed within the turbine compartment, wherein the turbine includes an axis of rotation; and
directional means disposed at the inlet for directing a fluid from the inlet toward one side of the axis of rotation.

12. The water turbine module according to claim 11, wherein the directional means comprises a plurality of vanes extending inwardly from the inlet and angled to direct the fluid toward the one side of the axis of rotation.

13. The water turbine module according to claim 11, wherein the directional means comprises a louvered wall extending outwardly from the inlet at an angle oblique to the inlet.

14. The water turbine module according to claim 11, further comprising a flow control panel extending from the inlet toward the outlet, wherein the flow control panel is configured to direct a flow of water around the turbine.

15. A water turbine generator station comprising:
a frame having an upstream portion and a downstream portion;
a water turbine module releasably disposed within the downstream portion;
an electrical generator module releasably disposed within the downstream portion, adjacent to the water turbine module; and
an inlet flow module releasably disposed in the upstream portion adjacent to the water turbine module.

16. The water turbine generator station according to claim 15, wherein the frame further comprises a plurality of support members extending downwardly therefrom.

17. The water turbine generator station according to claim 15, wherein the frame is vertically movable.

18. An inlet flow module for a water turbine comprising:
a frame having an upstream portion;
a first guard comprising a plurality of restraint members, the first guard being obliquely disposed across the upstream portion of the frame, each of the plurality of restraint members being spaced from an adjacent restraint member by a predetermined distance;
a second guard disposed downstream of the first guard, the second guard comprising a mesh screen extending across the frame; and
a louvered door disposed downstream of the second guard, wherein the louvered door is remotely operable.

19. A power generation module comprising:
a watertight compartment configured to enclose an electrical generator, the watertight compartment including at least one actuator extending therethrough; and
a non-watertight compartment being in electrical communication with the watertight compartment.

20. The power generation module according to claim 20, further comprising:
an electrical generator disposed within the watertight compartment, wherein the at least one actuator comprises an electrical generator input, and wherein the output of the electrical generator is in electrical communication with the non-watertight compartment.

21. The power generation module according to claim 20, wherein the at least one actuator comprises at least two actuators.

22. An electrical generating barge comprising:
a hull having a plurality of compartments;
a water turbine disposed within a first of the plurality of compartments; and
an electrical generator coupled to the water turbine, wherein the electrical generator is disposed within a second of the plurality of compartments,
wherein the hull may be ballasted to locate the water turbine below a water level.
